(19) United States
(12) Patent Application Publication
(10) Pub. No.: US 2026/0139794 A1
(43) Pub. Date: May 21, 2026

(54) HANDHELD GIMBAL

(71) Applicant: Arashi Vision Inc., Shenzhen (CN)

(72) Inventors: Lifen LU, SShenzhen (CN); Gu CHEN, Shenzhen (CN); Guogang LV, Shenzhen (CN); Xianhong JIANG, Shenzhen (CN); Dehua MO, Shenzhen (CN)

(73) Assignee: Arashi Vision Inc., Shenzhen (CN)

(21) Appl. No.: 19/451,043

(22) Filed: Jan. 16, 2026

Related U.S. Application Data
(63) Continuation of application No. PCT/CN2024/073843, filed on Jan. 24, 2024.

(51) Int. Cl. F16M 13/04; G03B 17/56

(52) U.S. Cl. CPC F16M 13/04; G03B 17/563

(57) ABSTRACT

A handheld gimbal for controlling a shooting device includes a handle; a shaft assembly, the shaft assembly including a first shaft assembly, the first shaft assembly including a first shaft arm and a first motor connected to the first shaft arm, the first motor being configured to drive the first shaft arm to rotate the shooting device as a yaw motor or a pitch motor; and a rotating structure between the handle and the first motor to enable the first motor to rotate relative to the handle so that the first motor switches between the yaw motor and the pitch motor.

### CROSS-REFERENCE TO RELATED APPLICATION

The present application is a continuation of International Application No. PCT/CN2024/073843, filed Jan. 24, 2024, the entire content of which being incorporated herein by reference in its entirety.

### TECHNICAL OF FIELD

This application relates to a field of gimbal technology, and in particular to a handheld gimbal.

### BACKGROUND

A handheld gimbal can be used to fix a shooting device. A shaft assembly of the handheld gimbal can also support and adjust an attitude of the shooting device to meet different shooting needs of a user.

Some traditional handheld gimbals have limited rotational travel of a camera's pitch angle when controlling the camera's pitch movement, which is insufficient to meet user needs and negatively impacts user experience.

### SUMMARY

In a first aspect, a handheld gimbal for controlling a shooting device includes a handle; a shaft assembly, the shaft assembly including a first shaft assembly, the first shaft assembly including a first shaft arm and a first motor connected to the first shaft arm, the first motor being configured to drive the first shaft arm to rotate the shooting device as a yaw motor or a pitch motor; and a rotating structure between the handle and the first motor to enable the first motor to rotate relative to the handle so that the first motor switches between the yaw motor and the pitch motor.

### BRIEF DESCRIPTION OF THE DRAWINGS

To more clearly illustrate the technical solutions in the embodiments of this application or the conventional technology, the drawings used in the description of the embodiments or the conventional technology will be briefly introduced below. Obviously, the drawings described below are only some embodiments of this application. For those skilled in the art, other drawings can be obtained based on these drawings without creative effort.

FIG. 1 is a structural schematic diagram of a handheld gimbal provided in one embodiment of this application.

FIG. 2 is an exploded view of a handheld gimbal provided in one embodiment of this application.

FIG. 3 is a partially enlarged exploded view of a handheld gimbal provided in one embodiment of this application.

FIG. 4 is a side view of the handheld gimbal when the first motor switches provided in one embodiment of this application.

FIG. 5 is a perspective view of a handheld gimbal when the first motor switches provided in one embodiment of this application.

FIG. 6 is a schematic diagram of the first motor when it is used as a pitch motor provided in one embodiment of this application.

FIG. 7 is another schematic diagram of the first motor when it is used as a pitch motor provided in one embodiment of this application.

FIG. 8 is a structural schematic diagram of a second rotating assembly provided in one embodiment of this application.

FIG. 9 is an exploded view of a second rotating assembly provided in one embodiment of this application.

FIG. 10 is a cross-sectional view of a second rotating assembly provided in one embodiment of this application.

FIG. 11 is a schematic diagram of a structure of a second rotating seat provided in one embodiment of this application.

FIG. 12 is an exploded view of a second rotating seat and a fixed seat provided in one embodiment of this application.

FIG. 13 is another structural schematic diagram of a second rotating assembly provided in one embodiment of this application.

FIG. 14 is a cross-sectional view taken at the dashed line of a second rotating assembly provided in the embodiment of FIG. 13 of this application.

FIG. 15 is a side view of a handheld gimbal provided in one embodiment of this application.

FIG. 16 is another side view of a handheld gimbal provided in one embodiment of this application.

FIG. 17 is another structural schematic diagram of a handheld gimbal provided in one embodiment of this application.

### FIGURE SYMBOLS

10. Handheld gimbal; 20. Shooting device; 100. First shaft assembly; 110. First motor; 120. First shaft arm; 200. Second shaft assembly; 210. Second motor; 220. Second shaft arm; 300. Third shaft assembly; 310. Third motor; 320. Clamping member; 400. Handle; 410. Telescopic rod; 500. Rotating mechanism; 510. First rotating base; 520. Second rotating assembly; 521. Second rotating base; 5211. Main body; 5212. Rotating shaft portion; 5213. Connecting portion; 522. Fixing base; 5221. Rotating hole, 530. Elastic member; 540. Fastener; 550. Limiting protrusion; 551. Sliding surface; 552. top surface; 560. Limiting groove; 561. Buffer surface; 562. Bottom surface; 571. First limiting rib; 572. Second limiting rib; 600. Control component; a. axis of the first motor; b. First rotating axis; c. Second rotating axis.

### DETAILED DESCRIPTION

To make the above-mentioned objectives, features, and advantages of this application more apparent and understandable, specific embodiments of this application are described in detail below with reference to accompanying drawings. Many specific details are set forth in the following description to provide a thorough understanding of this application. However, this application can be implemented in many other ways different from those described herein, and those skilled in the art can make similar modifications without departing from spirit of this application. Therefore, this application is not limited to the specific embodiments disclosed below.

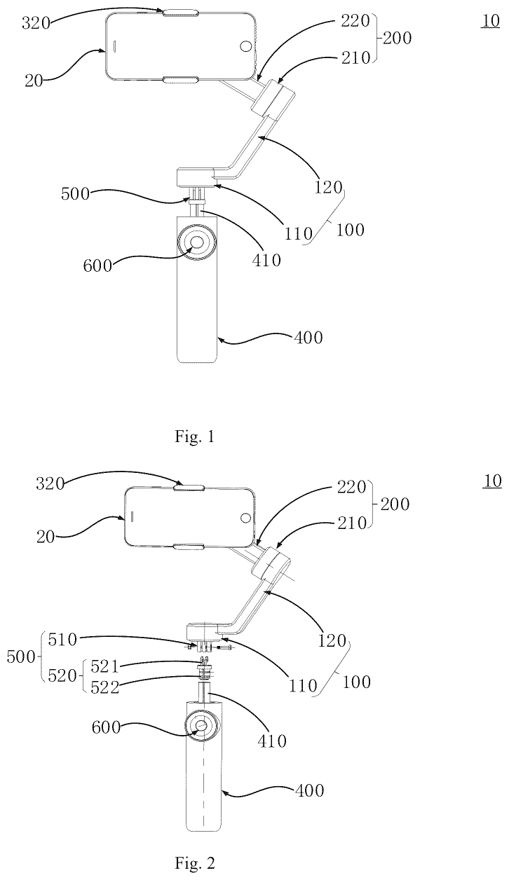

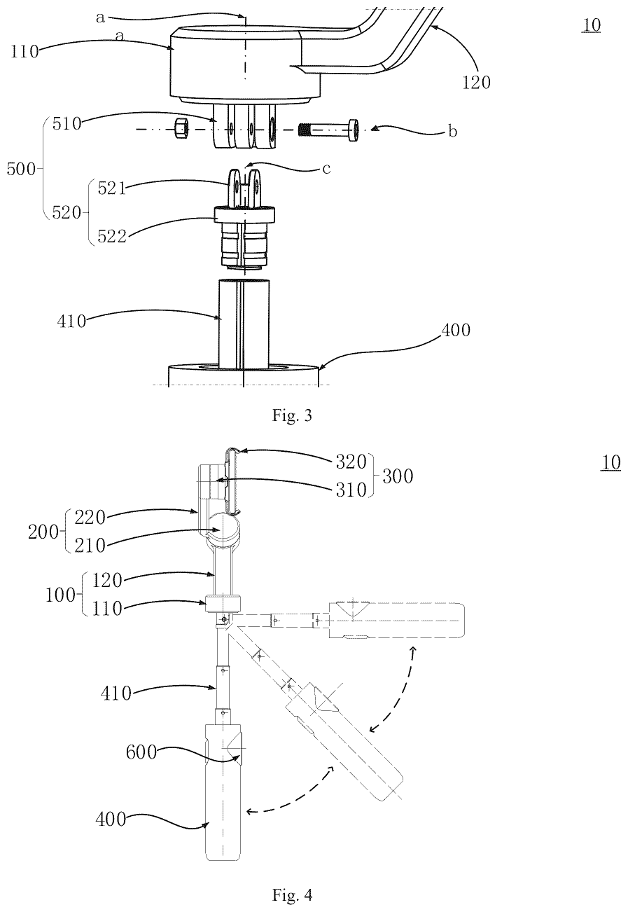

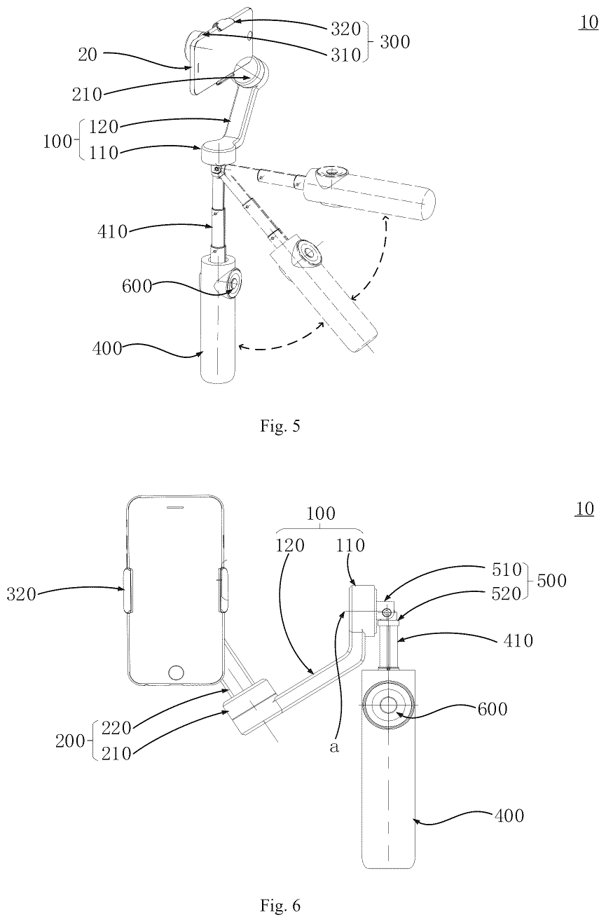

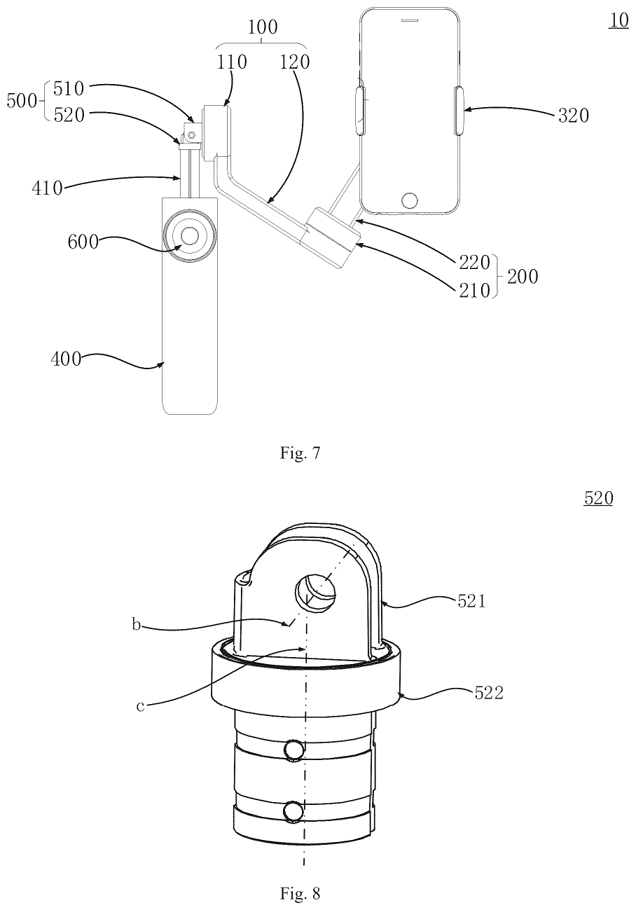

Please refer to FIGS. 1, 2, 3, 4, 5, 6, and 7. In some embodiments, this application provides a handheld gimbal 10, which can be configured to control a shooting device 20. The handheld gimbal 10 includes a handle 400, a shaft assembly, and a rotating mechanism or structure 500. The shaft assembly can be used to support and drive the shooting device 20 to adjust its attitude. The shaft assembly includes a first shaft assembly 100, which includes a first shaft arm 120 and a first motor 110 connected to the first shaft arm 120. The first motor 110 can drive the first shaft arm 120 to rotate, thereby driving rotation of the shooting device 20. The first motor 110 can function as a yaw motor or a pitch motor. As shown in FIGS. 2 and 3, the rotating mechanism 500 is located between the handle 400 and the first motor 110. The first motor 110 can rotate relative to the handle 400 through the rotating mechanism 500, so that the first motor 110 can switch from either the yaw motor or the pitch motor to the other. As shown in FIG. 1, the first motor 110 can function as a yaw motor. As shown in FIGS. 6 and 7, the first motor 110 can function as a pitch motor.

Before describing technical effects achievable by some embodiments of this application, it should be noted that some traditional handheld gimbals 10 often have multiple non-orthogonally arranged motors and shafts, requiring coordinated operation of multiple motors and shafts to adjust the pitch angle of the shooting device 20. Furthermore, due to their inherent structural limitations, the shaft assemblies of such traditional handheld gimbals 10 offer very limited adjustment of the pitch angle of the shooting device 20. That is, the rotational travel of the shooting device 20 in the pitch angle is small, making it difficult to meet user needs and impacting user experience.

To address the aforementioned problems, the handheld gimbal 10 described in some embodiments of this application can at least include following beneficial effects: When a user uses the handheld gimbal 10, generally speaking, the shooting device 20 can be roughly oriented towards the user's face under the drive of the shaft assembly of the handheld gimbal 10, so that the user can easily observe various shooting situations of the shooting device 20. The first motor 110 of the shaft assembly can rotate relative to the handle 400 through the rotating mechanism 500, so that the first motor 110 can be converted into a pitch motor or a yaw motor. For example, as shown in FIG. 1, when the handheld gimbal 10 is placed horizontally, the first motor 110 can act as a yaw motor, which can be considered as an axis a of the first motor being perpendicular to the horizontal ground. At this time, the first motor 110 can drive the shooting device 20 to rotate horizontally in front of the user, roughly parallel to the user's eyes. As another example, as shown in FIGS. 6 and 7, when the first motor 110 acts as a pitch motor, the axis a of the first motor is roughly parallel to the horizontal ground. At this time, the first motor 110 can drive the shooting device 20 to perform pitch movement in front of the user.

In other words, the handheld gimbal 10 according to some embodiments of this application does not require multiple motors to work together to adjust the pitch angle of the shooting device 20, as is the case with the traditional handheld gimbal 10 described above. The shaft assembly structure of this application is more streamlined. When it drives the shooting device 20 to make pitch movement, the first motor 110 can be directly converted into a pitch motor. The first motor 110 can work alone to achieve a wide range of pitch angle adjustment of the shooting device 20. This reduces the problem of the shaft assembly in the traditional solution being too limited in pitch angle adjustment, thereby meeting the user's needs for various usage scenarios that require the shooting device 20 to rotate significantly in pitch angle adjustment, enriching shooting methods and meeting the user's needs for shooting methods such as camera movement, low camera position, shooting the sky or shooting the ground.

For example, in some common usage scenarios, when a user holds the handle 400, the user may often choose to adjust the shooting device 20 to be at a position higher than the handle 400, so that the shooting device 20 is roughly at the same height as the user's eyes. This makes it easier for the user to observe the screen of the shooting device 20 to understand the shooting situation. Therefore, increasing the pitch operating angle of the handheld gimbal 10 is more in line with the user's usual attitude of the handheld gimbal 10 and the shooting device 20 it holds, and is more in line with the user's usage habits, thus bringing a better user experience.

For example, in a scenario where a user needs to move the camera to shoot, the first motor 110 of the handheld gimbal 10 of this application has a larger pitch angle range when pitching, which can achieve smooth lens tracking and maintain a stable picture when tracking the moving subject, allowing the audience to feel the dynamic impact.

For example, in scenarios where a user needs to shoot from a low angle, the first motor 110 of the handheld gimbal 10 of this application has a larger pitch travel when pitching, which allows a photographer to easily pitch the camera down to the ground or below the human eye's field of vision, creating a unique visual effect. This low-angle shooting can enhance the immersiveness of the scene and make the audience feel close to the subject being filmed.

For example, in a scenario where a user needs to shoot from a low angle, the first motor 110 of the handheld gimbal 10 of this application has a larger pitch travel when pitching, which allows the photographer to pitch the camera of the shooting device 20 at a sufficient angle to capture a landscape at a high place.

For example, in a scenario where a user needs to shoot from a high vantage point, the first motor 110 of the handheld gimbal 10 of this application has a larger pitch travel when pitching, allowing the photographer to pitch the camera of the shooting device 20 to look down at the ground and capture specific terrain, buildings, crowds, etc. This shooting method can present a brand-new angle and perspective, allowing the viewer to have a deeper understanding of the scene on the ground and a better observation effect.

Furthermore, since the handheld gimbal 10 according to some embodiments of this application requires only the first motor 110 to control the pitch movement of the shooting device 20, the overall user experience is improved.

Please refer to FIGS. 1, 4, 5, 6, and 7. In some embodiments, the first motor 110 can be rotated relative to the handle 400 to a first position and a second position via the rotating mechanism 500. As shown in FIG. 1, in the first position, the first motor 110 can function as a yaw motor; as shown in FIGS. 6 and 7, in the second position, the first motor 110 can function as a pitch motor.

As shown in FIGS. 6 and 7, in one embodiment, a control component 600 is provided on an outer peripheral surface of the handle 400. In the second position, the first motor 110 can drive the shooting device 20 through the first shaft arm 120, so that the orientation of the screen of the shooting device 20 is consistent with the orientation of the control component 600. The control component can refer to a component such as a control panel, a dial assembly, or a joystick, which can be used to control the handheld gimbal 10 and/or the shooting device 20. Taking the dial assembly and joystick as examples, the dial assembly is a control component that acquires user control commands through different rotation amounts. A user can easily control the shooting device 20 by adjusting rotation of a dial ring. For example, a user can adjust the ISO, white balance, focus, scrolling options, and switching settings of the shooting device 20 by rotating the dial assembly clockwise/counterclockwise. The joystick is a control component with extremely high freedom of movement, acquiring user control commands through the movement and/or rotation of the stick in different directions. A user can easily control the shooting device 20 by moving the joystick. For example, a user can easily select one or more focus points from multiple focus points and change a rotation angle of the shaft assembly by moving the joystick. Therefore, the setting in this embodiment allows the screen of the shooting device 20 to face the same direction as the control component 600. This can be considered as a side shooting mode. This is to ensure that even when the first motor 110 of the shaft assembly is used as a pitch motor, the shooting device 20 driven by the shaft assembly and the control component 600 on the handle 400 can be roughly facing the user at the same time. This makes it easier for the user to observe the shooting device 20 and operate the control component 600 at the same time, making operation more convenient and further improving user experience.

For example, in the embodiments shown in FIGS. 6 and 7, the control component 600 is a control panel, and the control panel is provided on the outer peripheral surface of the handle 400. In the second position, the first motor 110 can drive the shooting device 20 through the first shaft arm 120, so that the shooting device 20 is parallel to the control panel. The control panel on the handle 400 can be used to control the handheld gimbal 10 and/or the shooting device 20, such as adjusting overall attitude of the shaft assembly or adjusting the operating state of the shooting device 20. Therefore, the arrangement in this embodiment, where the shooting device 20 is parallel to the control panel, can be considered as a side-shooting mode. This ensures that even when the first motor 110 of the shaft assembly is used as a pitch motor, the shooting device 20 driven by the shaft assembly and the control panel on the handle 400 can simultaneously face approximately the user, making it easier for the user to observe the shooting device 20 and operate the control panel at the same time, thus improving user experience.

As shown in FIGS. 1, 6, and 7, in some embodiments, an axis a of the first motor in the first position shown in FIG. 1 is set at an angle to an axis a of the first motor in the second position shown in FIGS. 6 and 7, with the angle being 85 degrees to 95 degrees. This structural arrangement can be considered as the axis a of the first motor when acting as a yaw motor being approximately perpendicular to the axis a of the first motor when acting as a pitch motor. That is, when the first motor 110 switches back and forth between acting as a yaw motor and a pitch motor, the axis a of the first motor changes approximately 85 degrees to 95 degrees. This setting is because, on the one hand, from the user's perspective, they can only roughly perceive that the first motor 110 has undergone an angle change of about 90 degrees. On the other hand, a perfect 90-degree angle does not exist in the real world. Therefore, the angle between the axis a of the first motor in the first position and the axis a of the first motor in the second position is set to 85 to 95 degrees. While satisfying the user's needs for the first motor 110 to switch back and forth between the pitch motor and the yaw motor, it can also reduce the manufacturing precision requirements and assembly requirements of related components, reduce manufacturing difficulty, and improve yield and production efficiency.

Referring to FIG. 3, in some embodiments, the rotating mechanism 500 includes a first rotating base 510 and a second rotating assembly 520 disposed on the handle 400. The second rotating assembly 520 is rotatably connected to the first rotating base 510, and the first rotating base 510 is fixedly connected to the first motor 110. The first rotating base 510 can drive the first motor 110 to rotate relative to the second rotating assembly 520 about a first rotating axis b, and the second rotating assembly 520 can drive the first motor 110 to rotate relative to the handle 400 about a second rotating axis c, so that the first motor 110 can switch from either the yaw motor or the pitch motor to the other. With the first rotating base 510 and the first motor 110 fixed, the second rotating assembly 520 can drive the first motor 110, driven by the first rotating base 510, to rotate relative to the handle 400. This better ensures that when the first motor 110 drives the shooting device 20 to perform pitch movements, it is roughly facing the user.

Furthermore, as shown in FIG. 8, in some embodiments, the first rotating axis b and the second rotating axis c are perpendicular to each other.

Furthermore, in some embodiments, the first motor 110 is capable of rotating relative to the second rotating assembly 520 to the first position or the second position under the drive of the first rotating base 510. As shown in FIG. 1, in the first position, the axis a of the first motor is parallel to the second rotating axis c of the second rotating assembly 520; as shown in FIG. 6 and FIG. 7, in the second position, the axis a of the first motor is perpendicular to the second rotating axis c of the second rotating assembly 520.

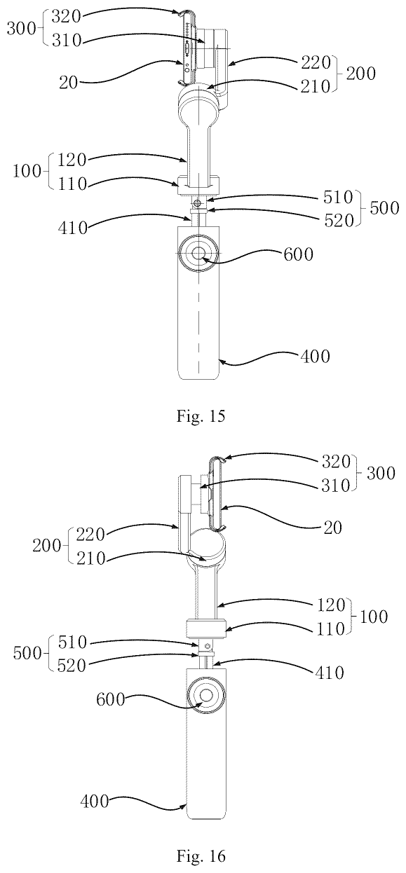

Please refer to FIGS. 6, 7, 8, 9, 10, 15, and 16. In some embodiments, the second rotating assembly 520 includes a fixed base 522 disposed on the handle 400 and a second rotating base 521 rotatably connected to the fixed base 522 around the second rotating axis c. The first rotating base 510 can drive the first motor 110 to rotate relative to the second rotating base 521 around the first rotating axis b, and the second rotating base 521 can drive the first motor 110 to rotate around the second rotating axis c. As shown in FIGS. 15 and 16, the second rotating assembly 520 can increase the adjustment of the heading angle of the first motor 110, giving it a larger adjustment angle for the shooting device 20. Furthermore, when using the handheld gimbal 10, a user typically prefers to have the control panel on the handle 400 facing the user for easier control. However, the pitch movement of the pitch motor is relative to the user. Therefore, the second rotating base 521 needs to drive the first motor 110 to rotate around the second rotating axis c to ensure that the first motor 110 can function as a pitch motor when the control panel is facing the user. For example, in the embodiments shown in FIGS. 6 and 7, when the first motor 110 functions as a pitch motor, the axis of the first motor 110 is not only approximately perpendicular to the second rotating axis c, but the axis a of the first motor is also approximately parallel to the control panel.

As shown in FIGS. 1 and 3, in some embodiments, the handle 400 further includes a telescopic rod 410 disposed within the handle 400. The telescopic rod 410 is telescopic along the second rotating axis c. A fixed base 522 is installed at the top of the telescopic rod 410 and is telescopic relative to the handle 400 during the telescopic extension and retraction of the telescopic rod 410. The telescopic rod 410 can extend or retract relative to the handle 400. A user can flexibly adjust a length of the telescopic rod 410 according to actual needs, thereby adjusting a distance between the shaft assembly connecting the top of the telescopic rod 410 and the handle 400, and further adjusting a distance between the shooting device 20 carried and driven by the shaft assembly and the handle 400, adapting to the user's usage needs in different scenarios.

In some embodiments, the handheld gimbal 10 further includes a wire fixed to the telescopic rod 410, one end of the wire being electrically connected to a battery and a control panel on the handle 400, and the other end of the wire being electrically connected to the shaft assembly, the battery being used to power the shaft assembly, and the control panel being used to control the movement of the shaft assembly.

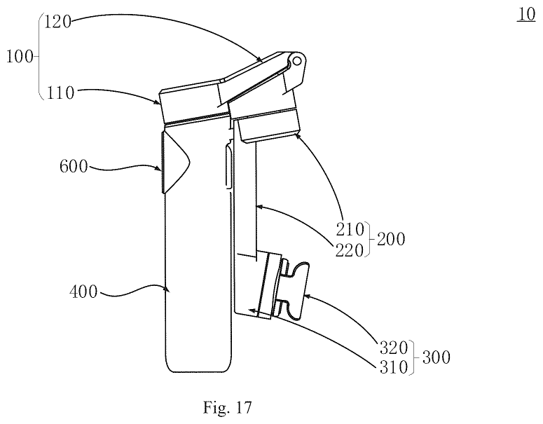

As shown in FIG. 1, in some embodiments, an end face of the top of the handle 400 may be perpendicular to the axis of the handle 400, which can be considered as the end face of the top of the handle 400 being horizontal. In other embodiments, as shown in FIG. 17, an end face of the top of the handle 400 may also be at an angle to the axis of the handle 400, which can be considered as the end face of the top of the handle 400 being inclined. For example, when the first motor 110 is in the first position, that is, when the first motor 110 acts as a heading motor and is located at the top of the handle 400, and the end face of the top of the handle 400 is at an angle to the axis of the handle 400, if the telescopic rod 410 is in the retracted state, in order to achieve a better storage effect, the first motor 110 can be slightly rotated relative to the end face of the top of the handle 400 through the rotating mechanism 500 until the housing of the first motor 110 is completely attached to the top of the handle 400. More specifically, the bottom of the first motor 110 is fixed to the first rotating base 510. That is, the first rotating seat 510 can rotate relative to the second rotating base 521 until the housing of the first motor 110 is in contact with the inclined end face of the top of the handle 400.

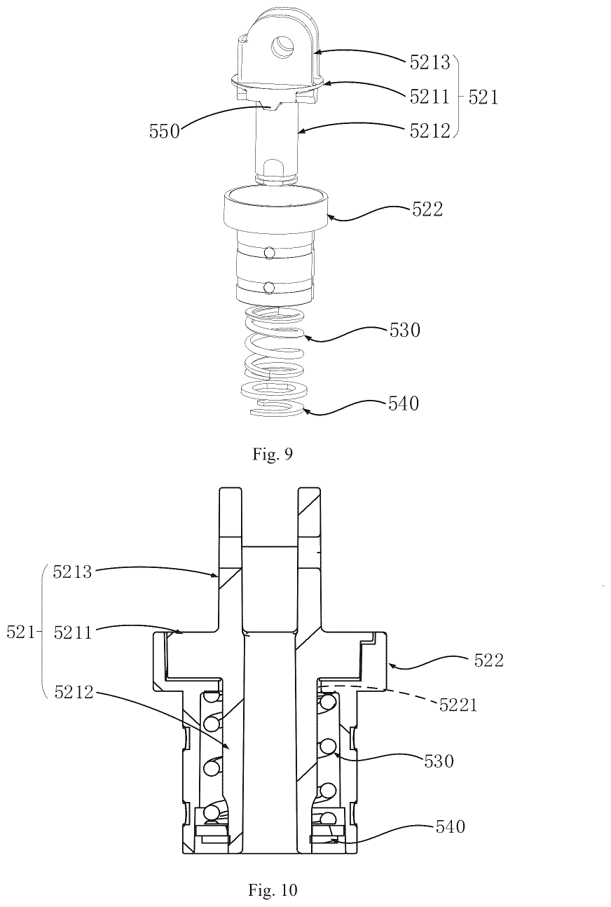

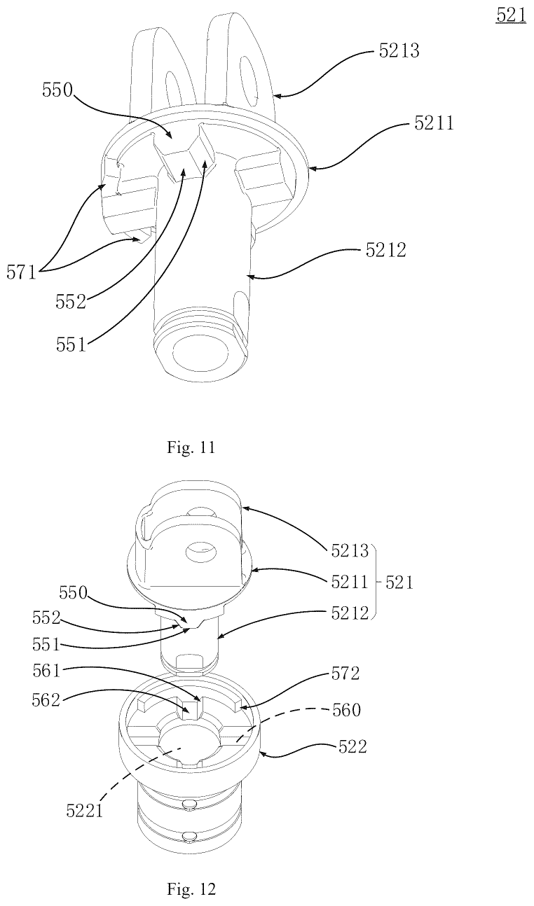

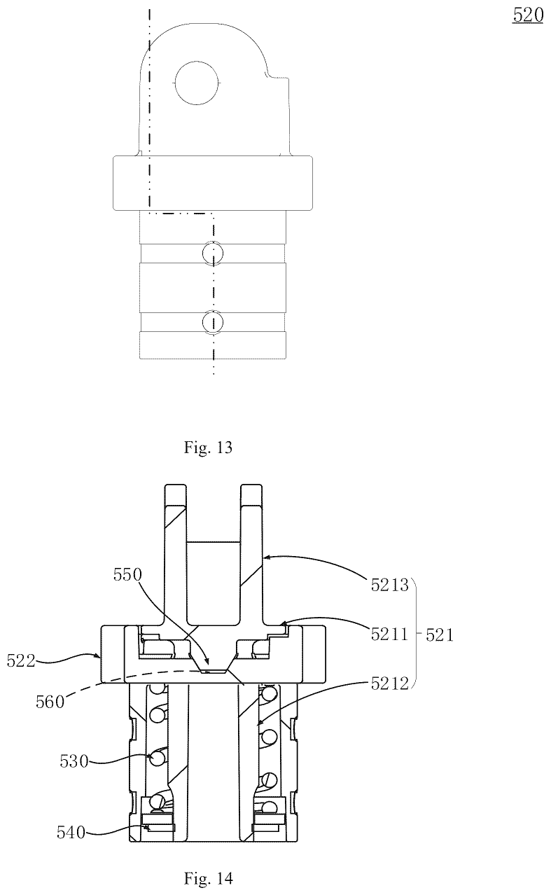

As shown in FIGS. 9, 10, 11, 12, 13, and 14, in some embodiments, the second rotating assembly 520 further includes an elastic member or structure 530, the second rotating base 521 is connected to the fixed base 522 via the elastic member 530, and the second rotating base 521 is rotatable relative to the fixed base 522 along the circumference of the fixed base 522. One of the second rotating base 521 or the fixed base 522 is provided with a plurality of circumferentially spaced limiting grooves 560, and the other of the second rotating base 521 or the fixed base 522 is provided with a plurality of circumferentially spaced limiting protrusions 550, which can extend into the limiting grooves 560 under the elastic action of the elastic member 530. When the second rotating base 521 rotates relative to the fixed base 522, any one of the limiting protrusions 550 can overcome the elastic force of the elastic member 530 and move from one limiting groove 560 to another limiting groove 560. For example, in the embodiment shown in FIG. 11, the second rotating base 521 is provided with limiting protrusions 550, and the fixed base 522 is provided with limiting grooves 560. In another embodiment, the second rotating base 521 is provided with limiting grooves 560, and the fixed base 522 is provided with limiting protrusions 550.

Understandably, without the limiting protrusion 550 and limiting groove 560, the second rotating base 521 could easily rotate relative to the fixed base 522. If the user is holding the handheld gimbal 10 in motion, this could cause the shaft assembly and the shooting device 20 to shift position, thus affecting the user's normal shooting. However, this embodiment is designed so that even if the handheld gimbal 10 shakes during use, the elastic force of the elastic member 530 can still hold the limiting protrusions 550 against the limiting grooves 560, thereby reducing the risk of the shaft assembly and shooting device 20 shifting position due to the second rotating base 521 rotating relative to the fixed base 522 without human intervention. With human intervention, if the user actively wants the second rotating base 521 to rotate relative to the fixed base 522, a force in the rotational direction can be applied to the second rotating base 521 until either of the limiting protrusions 550 can overcome the elastic force of the elastic member 530 and move from one limiting groove 560 to another.

Further, as shown in FIGS. 11 and 12, in some embodiments, a plurality of the limiting grooves 560 are equally spaced along the circumference of the fixed base 522, and a plurality of limiting protrusions 550 are equally spaced along the circumference of the second rotating base 521. This structural arrangement means that when any limiting protrusion 550 moves from one limiting groove 560 to the next, the change in the rotation angle of the second rotating base 521 relative to the fixed base 522 is the same. For example, as shown in FIGS. 11 and 12, taking the number of limiting grooves 560 and limiting protrusions 550 as four, the four limiting grooves 560 are equally spaced along the circumference of the fixed base 522, and the four limiting protrusions 550 are equally spaced along the circumference of the second rotating base 521. When the user moves any one of the limiting protrusions 550 from one limiting groove 560 to the next, the rotation angle change of the second rotating base 521 relative to the fixed base 522 is approximately 90 degrees. Similarly, if the number of limiting grooves 560 and limiting protrusions 550 is three, when the user moves any one of the limiting protrusions 550 from one limiting groove 560 to the next, the rotation angle change of the second rotating base 521 relative to the fixed base 522 is approximately 120 degrees. This is merely a simple example and does not indicate or imply that the number of limiting protrusions 550 and limiting grooves 560 can only be as mentioned above. Understandably, the number of limiting protrusions 550 and limiting grooves 560 can also be two, five or more, and can be adjusted according to actual needs.

Furthermore, as shown in FIG. 11, in some embodiments, each of the limiting protrusions 550 has two sliding surfaces 551 disposed opposite to each other along the circumference of the second rotating base 521.

Furthermore, as shown in FIG. 12, in some embodiments, each of the limiting grooves 560 has two buffer surfaces 561 that are relatively spaced apart along the circumference of the fixing base 522.

Furthermore, as shown in FIG. 14, in some embodiments, the limiting protrusion 550 is adapted to the limiting groove 560.

In some embodiments, the buffer surface 561 on either side is set at an angle to a bottom surface 562 of the limiting groove 560 at a first predetermined angle, which is 30-120 degrees. This 30-120 degree angle between the buffer surface 561 and the bottom surface 562 of the limiting groove 560 can, to some extent, reduce difficulty of the limiting protrusion 550 moving out of the limiting groove 560, and prevent connection between the limiting protrusion 550 and the limiting groove 560 from being too tight, making it difficult for the user to rotate the second rotating base 521 relative to the fixed base 522. Understandably, the smaller the angle of the first predetermined angle, the steeper the buffer surface 561 is relative to the bottom surface 562 of the limiting groove 560, making it more difficult for the limiting protrusion 550 to move out of the limiting groove 560, and the better the relative fixing effect of the second rotating base 521 and the fixed base 522. The larger the angle of the first predetermined angle, the smoother the transition between the buffer surface 561 and the bottom surface 562 of the limiting groove 560, making it easier for the limiting protrusion 550 to move out of the limiting groove 560.

In some embodiments, the first predetermined angle is 60-90 degrees.

In some embodiments, the sliding surface 551 on either side is set at an angle to the top surface 552 of the limiting protrusion 550 at a second predetermined angle, which is 30-120 degrees. This 30-120 degree angle between the sliding surface 551 and the top surface 552 of the limiting protrusion 550 can, to some extent, reduce difficulty of the limiting protrusion 550 moving out of the limiting groove 560, and prevent connection between the limiting protrusion 550 and the limiting groove 560 from being too tight, making it difficult for the user to rotate the second rotating base 521 relative to the fixed base 522. Understandably, the smaller the second predetermined angle, the steeper the sliding surface 551 is relative to the top surface 552 of the limiting protrusion 550, making it more difficult to move the limiting protrusion 550 out of the limiting groove 560, and the better the relative fixing effect of the second rotating base 521 and the fixed base 522. The larger the second predetermined angle, the smoother the transition between the sliding surface 551 and the top surface 552 of the limiting protrusion 550, making it easier to move the limiting protrusion 550 out of the limiting groove 560.

In some embodiments, the second predetermined angle is 60-90 degrees.

Referring to FIGS. 11 and 12, in some embodiments, the second rotating base 521 is provided with a first limiting rib 571, and the fixed base 522 is provided with a second limiting rib 572. The second limiting rib 572 is located on a rotation path of the first limiting rib 571 to limit the rotation of the second rotating base 521 relative to the fixed base 522. It is understood that if the second rotating base 521 always rotates in either a clockwise or counterclockwise direction, it may damage surrounding wires and other electronic components. This embodiment, however, prevents the second rotating base 521 from rotating unrestrictedly relative to the fixed base 522.

Please refer to FIG. 10. In some embodiments, the fixing base 522 has a top side and a bottom side arranged opposite to each other and is provided with a rotating hole 5221 that passes through the top side and the bottom side. The second rotating base 521 includes a main body 5211, and a rotating shaft portion 5212 and a connecting portion 5213 connected to opposite sides of the main body 5211. The connecting portion 5213 is rotatably connected to the first rotating base 510. The main body 5211 is located on the top side of the fixed base 522. The rotating shaft portion 5212 passes through the rotating hole 5221 into the fixed base 522. Under the elastic force of the elastic member 530, the rotating shaft portion 5212 can pull the main body 5211 to abut against the top side of the fixed base 522. Either the top side of the main body 5211 or the top side of the fixed base 522 is provided with the limiting groove 560, and the other one of the top side of the main body 5211 or the top side of the fixed base 522 is provided with the limiting protrusion 550.

Further, as shown in FIGS. 9 and 10, in some embodiments, the second rotating assembly 520 further includes a fastener 540, which is disposed at the end of the rotating shaft portion 5212 away from the main body 5211. One end of the elastic member 530 elastically abuts against the fastener 540, and the other end of the elastic member 530 elastically abuts against the bottom side of the fixed base 522. The elastic member 530 may be a compression spring, etc., and the fastener 540 may be a retaining ring, etc.

In some embodiments, the handheld gimbal 10 further includes a processor and a sensor for sensing an attitude of the shaft assembly to confirm whether the first motor 110 is in the second position. The sensor may include, but is not limited to, an accelerometer, gyroscope, magnetometer, attitude sensor chip, or vision sensor. When the sensor detects that the first motor 110 is in the second position, the handheld gimbal is in side-shooting mode. In the side-shooting mode, the first motor of the handheld gimbal switches to a pitch motor, and its corresponding pitch control limit angle increases accordingly. This allows for accurate acquisition of the gimbal's attitude, better understanding of the user's intent, and improved user experience.

In some embodiments, the sensor includes a first attitude sensor and a second attitude sensor. The first attitude sensor is disposed within the shaft assembly to sense the attitude of the shaft assembly and generate a corresponding first attitude value. The second attitude sensor is disposed within the handle 400 to sense the attitude of the handle 400 and generate a corresponding second attitude value. The difference between the first attitude value and the second attitude value may be used by the processor or circuitry to determine whether the first motor 110 is located in the second position. The first attitude sensor, located inside the shaft assembly, can sense the attitude of the shaft assembly and generate a corresponding first attitude value, which helps determine information such as the direction, tilt angle, or rotation angle of the shaft assembly, thus determining the attitude of the shaft assembly. The second attitude sensor, located inside the handle 400, can sense the attitude of the handle 400 and generate a corresponding second attitude value. This helps determine information such as the direction, tilt angle, or rotation angle of the handle 400, thus determining the attitude of the handle 400. By the processor configured to compare the difference between the first attitude value and the second attitude value, it can be determined whether the first motor 110 is located in the second position relative to the handle 400. This comparison is based on the relative attitude information of the shaft assembly and the handle 400, thereby determining the position state of the motor. In short, this embodiment creatively uses a first attitude sensor and a second attitude sensor to acquire and judge the attitude information of the shaft assembly and the handle 400, so as to detect the current attitude of the handheld gimbal 10 and determine whether the first motor 110 is in the second position. This helps to realize the attitude control, position detection or motion monitoring functions of related equipment or systems.

Referring to FIG. 1, in some embodiments, the first shaft arm 120 has two ends that are far apart from each other, either the stator or the rotor of the first motor 110 is fixed to the first rotating base 510, and the other of the stator or the rotor of the first motor 110 is fixed to one end of the first shaft arm 120 and is used to drive the first shaft arm 120.

As shown in FIGS. 15 and 16, in some embodiments, the shaft assembly further includes a second shaft assembly 200 and a third shaft assembly 300. The second shaft assembly 200 includes a second motor 210 disposed on the first shaft arm 120 and a second shaft arm 220 connected to the second motor 210, the second shaft arm 220 having two ends spaced apart from each other. Either the stator or the rotor of the second motor 210 is fixed to the other end of the first shaft arm 120, and the other one of the stator or the rotor of the second motor 210 is fixed to one end of the second shaft arm 220, the second motor 210 being used to drive the second shaft arm 220 to rotate. The third shaft assembly 300 includes a third motor 310 disposed on the second shaft arm 220 and a clamping member or structure 320 for clamping the shooting device 20. Either the stator or the rotor of the third motor 310 is fixed to the other end of the second shaft arm 220, and the other of the stator or the rotor of the third motor 310 is connected to the clamping member 320 and used to drive the rotation of the clamping member 320 and the shooting device 20. In the first position, the first motor 110 can be used as a yaw motor, the second motor 210 can be used as a pitch motor, and the third motor 310 can be used as a roll motor. In the second position, the first motor 110 can be used as a pitch motor, the second motor 210 can be used as a yaw motor, and the third motor 310 can be used as a roll motor. The first shaft arm 120 can be any of the following shapes: straight arm, curved arm, or arc-shaped arm. Similarly, the second shaft arm 220 can also be any of the following shapes: straight arm, curved arm, or arc-shaped arm. The only requirement is that the entire shaft assembly can normally and coordinately drive the shooting device 20 when the first motor 110 switches between the first and second positions. Furthermore, it should be noted that the above explanation of the first motor 110, the second motor 210, and the third motor 310 is intended to aid in understanding the operating effect of the handheld gimbal 10 of this application, and is not intended to indicate or imply that the first motor 110, the second motor 210, and the third motor 310 can only function as described above. Therefore, the above explanation can be interpreted more broadly as long as it achieves the beneficial effects desired by the handheld gimbal 10 of this application.

The technical features of the above embodiments can be combined in any way. For the sake of brevity, not all possible combinations of the technical features in the above embodiments are described. However, as long as there is no contradiction in the combination of these technical features, they should be considered to be within the scope of this specification.

The embodiments described above are merely illustrative of several implementation methods of this application, and while the descriptions are relatively specific and detailed, they should not be construed as limiting the scope of the patent application. It should be noted that those skilled in the art can make various modifications and improvements without departing from the concept of this application, and these all fall within the protection scope of this application. Therefore, the protection scope of this patent application should be determined by the appended claims.

In the description of this application, it should be understood that if the terms “center”, “longitudinal”, “lateral”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential”, etc. appear, the orientation or positional relationship indicated by these terms is based on the orientation or positional relationship shown in the accompanying drawings, and is only for the convenience of describing this application and simplifying the description, and does not indicate or imply that the device or element referred to must have a specific orientation, or be constructed and operated in a specific orientation, and therefore should not be construed as a limitation of this application.

Furthermore, where the terms “first” and “second” appear, these terms are for descriptive purposes only and should not be construed as indicating or implying relative importance or implicitly specifying the number of technical features indicated. Thus, a feature defined with “first” or “second” may explicitly or implicitly include at least one of those features. In the description of this application, where the term “multiple” appears, “multiple” means at least two, such as two, three, etc., unless otherwise explicitly specified.

In this application, unless otherwise expressly specified and limited, the terms “installation,” “connection,” “joining,” and “fixing,” etc., should be interpreted broadly. For example, they can refer to a fixed connection, a detachable connection, or an integral part; they can refer to a mechanical connection or an electrical connection; they can refer to a direct connection or an indirect connection through an intermediate medium; they can refer to the internal communication of two components or the interaction between two components, unless otherwise expressly limited. Those skilled in the art can understand the specific meaning of the above terms in this application based on the specific circumstances.

In this application, unless otherwise expressly specified and limited, the use of descriptions such as “above” or “below” the second feature indicates that the first and second features are in direct contact or indirect contact via an intermediate medium. Furthermore, “above,” “on top of,” and “over” the second feature can mean that the first feature is directly above or diagonally above the second feature, or simply that the first feature is at a higher horizontal level than the second feature. Similarly, “below,” “at bottom of,” and “under” the second feature can mean that the first feature is directly below or diagonally below the second feature, or simply that the first feature is at a lower horizontal level than the second feature.

It should be noted that if an element is referred to as being “fixed to” or “set on” another element, it can be directly on the other element or there may be an intervening element. If an element is considered to be “connected to” another element, it can be directly connected to the other element or there may be an intervening element. If so, the terms “vertical,” “horizontal,” “upper,” “lower,” “left,” “right,” and similar expressions used in this application are for illustrative purposes only and do not represent the only possible implementation.

In the description of this specification, references to terms such as “an embodiment,” “another implementation,” etc., indicate that a specific feature, structure, material, or characteristic described in connection with that embodiment or example is included in at least one embodiment or example of this application. In this specification, the illustrative descriptions of the above terms do not necessarily refer to the same embodiment or example. Unless otherwise defined, all technical and scientific terms used herein have the same meaning as commonly understood by one of ordinary skill in the art to which this application belongs. The terminology used herein is for the purpose of describing particular embodiments only and is not intended to be limiting of this application.

What is claimed is:

1. A handheld gimbal for controlling a shooting device, comprising:
a handle;
a shaft assembly, the shaft assembly including a first shaft assembly, the first shaft assembly including a first shaft arm and a first motor connected to the first shaft arm, the first motor being configured to drive the first shaft arm to rotate the shooting device as a yaw motor or a pitch motor; and
a rotating structure between the handle and the first motor to enable the first motor to rotate relative to the handle so that the first motor switches between the yaw motor and the pitch motor.

2. The handheld gimbal according to claim 1, wherein the first motor is configured to be rotated relative to the handle to a first position or a second position via the rotating structure; in the first position, the first motor functions as the yaw motor; and in the second position, the first motor functions as the pitch motor.

3. The handheld gimbal according to claim 2, wherein a control component is provided on an outer peripheral surface of the handle, and in the second position, the first motor is configured to drive the shooting device through the first shaft arm so that the shooting device is parallel to the control component or orientation of a screen of the shooting device is consistent with orientation of the control component.

4. The handheld gimbal according to claim 2, wherein an axis of the first motor in the first position is set at an angle to an axis of the first motor in the second position and the angle is within a range of 85 degrees to 95 degrees.

5. The handheld gimbal according to claim 3, wherein the rotating structure includes a first rotating base and a second rotating assembly disposed on the handle, the second rotating assembly being rotatably connected to the first rotating base, and the first rotating base being fixedly connected to the first motor; the first rotating base is configured to drive the first motor to rotate relative to the second rotating assembly around a first rotating axis, and the second rotating assembly is configured to drive the first motor to rotate relative to the handle around a second rotating axis, so as to enable the first motor to switch between the yaw motor and the pitch motor.

6. The handheld gimbal according to claim 5, wherein the first rotating axis and the second rotating axis are perpendicular to each other.

7. The handheld gimbal according to claim 5, wherein the first motor is configured to rotate relative to the second rotating assembly to the first position or the second position under drive of the first rotating base; in the first position, the axis of the first motor is parallel to the second rotating axis of the second rotating assembly; in the second position, the axis of the first motor is perpendicular to the second rotating axis of the second rotating assembly.

8. The handheld gimbal according to claim 5, wherein the second rotating assembly includes a fixed base disposed on the handle and a second rotating base rotatably connected to the fixed base around the second rotating axis, the first rotating base being configured to drive the first motor to rotate relative to the second rotating base around the first rotating axis, and the second rotating base being configured to drive the first motor to rotate around the second rotating axis.

9. The handheld gimbal according to claim 8, wherein the handle further includes a telescopic rod disposed within the handle, the telescopic rod being extendable and retractable along the second rotating axis, and the fixing base being mounted on a top end of the telescopic rod and being extendable and retractable relative to the handle under extension and retraction of the telescopic rod.

10. The handheld gimbal according to claim 9, wherein the handheld gimbal further includes a wire fixed to the telescopic rod, one end of the wire being electrically connected to a battery and a control component inside the handle, and the other end of the wire being electrically connected to the shaft assembly, the battery being configured to power the shaft assembly, and the control component being configured to control movement of the shaft assembly.

11. The handheld gimbal according to claim 8, wherein the second rotating assembly further includes an elastic structure, the second rotating base is connected to the fixed base through the elastic structure, and the second rotating base is rotatable relative to the fixed base in a circumferential direction of the fixed base, one of the second rotating base or the fixed base is provided with a plurality of circumferentially spaced limiting grooves, and the other of the second rotating base or the fixed base is provided with a plurality of circumferentially spaced limiting protrusions, the limiting protrusions being able to extend into the limiting grooves under elastic force of the elastic structure;
wherein, when the second rotating base rotates relative to the fixed base, one of the limiting protrusions overcomes the elastic force of the elastic structure and moves from one of the limiting grooves to another one of the limiting grooves.

12. The handheld gimbal according to claim 11, wherein the plurality of the limiting grooves are equally spaced along the circumference of the fixed base, and the plurality of the limiting protrusions are equally spaced along the circumference of the second rotating base;
each of the limiting grooves has two buffer surfaces that are relatively spaced apart along the circumference of the fixed base;
each of the limiting protrusions has two sliding surfaces arranged opposite to each other along the circumference of the second rotating base; and
the limiting protrusions are adapted to the limiting grooves respectively.

13. The handheld gimbal according to claim 12, wherein one of the two buffer surfaces is set at an angle to a bottom surface of one of the limiting grooves at a first predetermined angle, and the first predetermined angle is within a range of 30 degrees to 120 degrees.

14. The handheld gimbal according to claim 12, wherein one of the two sliding surfaces is set at an angle to a top surface of the limiting protrusion at a second predetermined angle, and the second predetermined angle is within a range of 30 degrees to 120 degrees.

15. The handheld gimbal according to claim 11, wherein the second rotating base is provided with a first limiting rib, the fixed base is provided with a second limiting rib, and the second limiting rib is located on a rotation path of the first limiting rib to limit rotation of the second rotating base relative to the fixed base.

16. The handheld gimbal according to claim 11, wherein the fixed base has a top side and a bottom side disposed opposite to each other and is provided with a rotating hole, the rotating hole passing through the top side and the bottom side; the second rotating base includes a main body, and a rotating shaft portion and a connecting portion connected to opposite sides of the main body; the connecting portion is rotatably connected to the first rotating base; the main body is located on a top side of the fixed base; the rotating shaft portion passes through the rotating hole into the fixed base; and the rotating shaft portion is configured to pull the main body against the top side of the fixed base under the elastic force of the elastic structure; one of the main body or the top side of the fixed base is provided with the limiting grooves; and the other of the main body or the top side of the fixed base is provided with the limiting protrusions.

17. The handheld gimbal according to claim 16, wherein the second rotating assembly further includes a fastener, the fastener being disposed at one end of the rotating shaft portion away from the main body, one end of the elastic structure elastically abutting against the fastener, and the other end of the elastic structure elastically abutting against the bottom side of the fixed base.

18. The handheld gimbal according to claim 1, wherein the handheld gimbal further includes a sensor to detect an attitude of the shaft assembly to determine whether the first motor is in the second position.

19. The handheld gimbal according to claim 18, wherein the sensor includes a first attitude sensor and a second attitude sensor, the first attitude sensor is disposed in the shaft assembly to detect an attitude of the shaft assembly and generate a corresponding first attitude value, the second attitude sensor is disposed in the handle to detect an attitude of the handle and generate a corresponding second attitude value, and a difference between the first attitude value and the second attitude value is configured to determine whether the first motor is in the second position.

20. The handheld gimbal according to claim 2, wherein the shaft assembly further includes a second shaft assembly and a third shaft assembly; the second shaft assembly includes a second motor disposed on the first shaft arm and a second shaft arm connected to the second motor, the second motor being configured to drive the second shaft arm to rotate; the third shaft assembly includes a third motor disposed on the second shaft arm and a clamping structure to clamp the shooting device, the third motor being connected to the clamping structure and being configured to drive the clamping structure and the shooting device to rotate;
in the first position, the first motor functions as a yaw motor, the second motor functions as a pitch motor, and the third motor functions as a roll motor; and
in the second position, the first motor functions as a pitch motor, the second motor functions as a yaw motor, and the third motor functions as a roll motor.
